(19) United States
(12) Patent Application Publication
(10) Pub. No.: US 2016/0045797 A1
(43) Pub. Date: Feb. 18, 2016

(54) Grip Strap with Anti-Shock and Ventilation Effects

(71) Applicant: Leo Jaw, Taichung City (TW)

(72) Inventor: Leo Jaw, Taichung City (TW)

(21) Appl. No.: 14/461,461

(22) Filed: Aug. 18, 2014

(51) Int. Cl. A63B 59/00; B32B 27/40; B32B 27/30; B32B 3/08

(52) U.S. Cl. CPC A63B 59/0014; B32B 3/085; B32B 27/40; B32B 27/306; A63B 59/0029; B32B 2307/51; B32B 2307/56

(57) ABSTRACT

A grip strap with anti-shock and ventilation effects includes a strap body including a front side and a back side opposite the front side. A plurality of elastic members is disposed on the back side of the strap body. The plurality of elastic members is arranged separately from one another. Each of the plurality of elastic members protrudes from the back side of the strap body in a direction away from the front side of the strap body.

### BACKGROUND OF THE INVENTION

1. Field of the Invention

The present invention relates to a grip strap and, particularly, to a grip strap with anti-shock and ventilation effects.

2. Description of the Related Art

TW Pat. No. M368467 shows a grip strap. The grip strap is elongated. The grip strap includes a fabric layer and an elastic layer. The fabric layer has a plurality of orifices. The elastic layer is made of a form, e.g., LATEX or natural rubber (NR). The elastic layer is adhered to a side of the fabric layer. The side of the fabric layer is in surface contact with a first attach side of the elastic layer. The elastic layer has a sheet and a plurality of permeable sections. When the grip strap is wrapped around a handle, it includes a second attach side of the elastic layer facing and abutting against the outer periphery of the handle. The first and second attach sides of the elastic layer are opposite from each other. Therefore, the second side of the elastic layer is in frictional contact with the handle. Additionally, the second side of the elastic layer contacts with the outer periphery of the handle without any gaps. However, a user will not experience effectual anti shock and ventilation effects when gripping the handle.

The present invention is, therefore, intended to obviate or at least alleviate the problems encountered in the prior art.

### SUMMARY OF THE INVENTION

According to the present invention, a grip strap with anti-shock and ventilation effects includes a strap body including a front side and a back side opposite the front side. A plurality of elastic members is disposed on the back side of the strap body. The plurality of elastic members is arranged separately from one another. Each of the plurality of elastic members protrudes from the back side of the strap body in a direction away from the front side of the strap body.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an object of the present invention to provide a grip strap with anti-shock and ventilation effects.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a grip strap with anti-shock and ventilation effects in accordance with the present invention.

FIG. 2 is a cross-sectional view taken along line 2-2 of FIG. 1.

FIG. 3 shows the grip strap of the present invention in use with a handle, with the grip strap wrapping around a handle.

FIG. 4 shows a user gripping the grip strap and the handle shown in FIG. 3.

FIG. 5 shows air flowing between the grip strap and the handle after the user pressing the grip strap.

FIG. 6 is a cross-sectional view showing air ventilation in the grip strap.

### DETAILED DESCRIPTION OF THE INVENTION

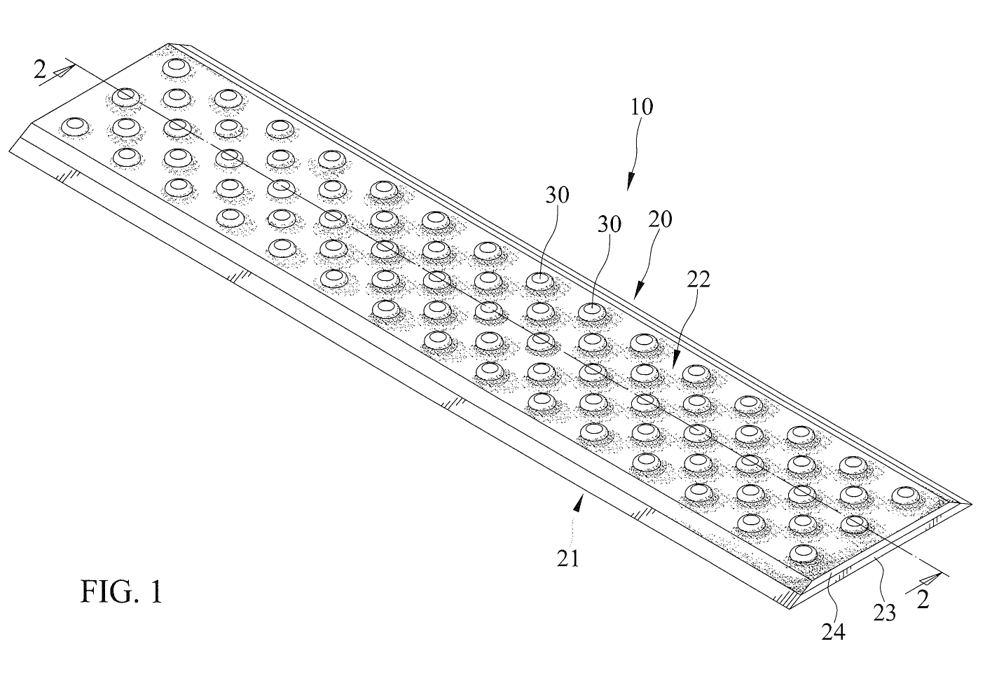

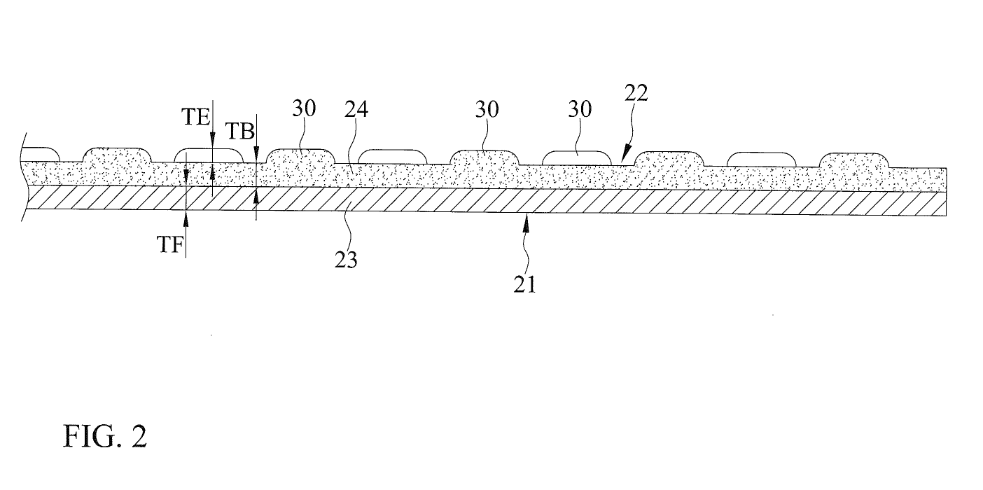

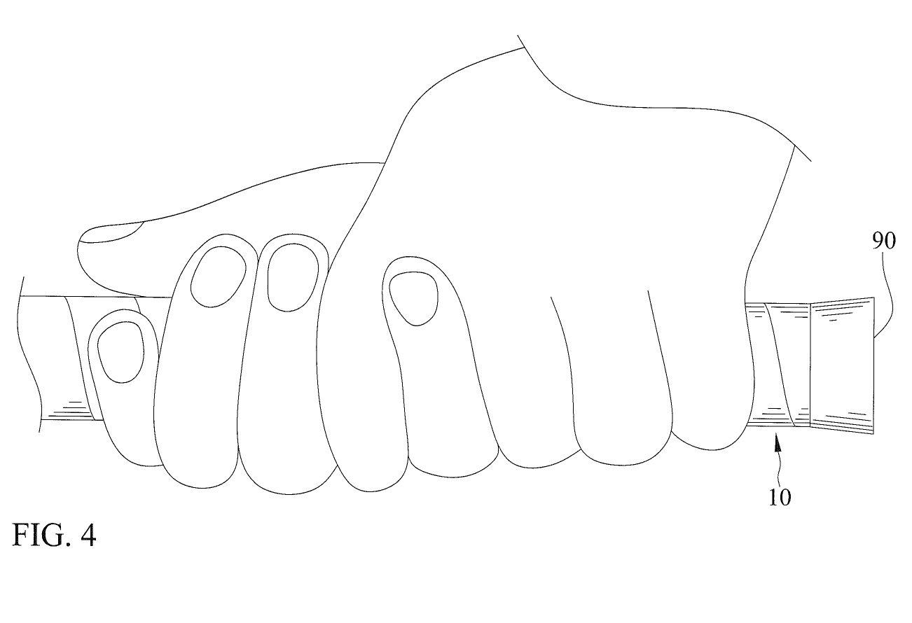

FIGS. 1 through 6 show a grip strap 10 with anti-shock and ventilation effects in accordance with the present invention. The grip strap 10 includes a strap body 20 including a front side 21 and a back side 22 opposite the front side 21. The front side 21 of the strap body 20 is a flat smooth edge without any cavities. The strap body 20 is elongated. The strap body 20 includes a substrate 23 and a cushion layer 24 overlapping the substrate 23. The substrate 23 and the cushion layer 24 are arranged in a thickness direction of the strap body 20. The substrate 23 is adjacent to the front side 21 of the strap body 20 and the cushion layer 24 is adjacent to the back side 22 of the strap body 20, respectively. The cushion layer 24 has an original thickness in the thickness direction of the strap body 20 defining a first thickness TB. The cushion layer 24 is made of an elastomer material. The cushion layer 24 is made of Ethylene Vinyl Acetate (EVA) or Thermoplastic Polyurethane (TPU).

A plurality of elastic members 30 is disposed on the back side 22 of the strap body 20. Each of the plurality of elastic members 30 has a bottom edge in contact with the back side 22 of the strap body 20 and a top edge opposite to the bottom edge. The top edges of the plurality of elastic members 30 are at the same height. The plurality of elastic members 30 is disposed along the longitudinal length direction of strap body 20. The thickness direction of the strap body 20 is perpendicular to a longitudinal length direction of the strap body 20. The plurality of elastic members 30 is arranged separately from one another. Each of the plurality of elastic members 30 does not contact with one another. The plurality of elastic members 30 includes each protruding from the back side 22 of the strap body 20 in a direction away from the front side 21 of the strap body 20. Each of the plurality of elastic member 30 has an original thickness in the thickness direction of the strap body 20 defining a second thickness TE. The second ii thickness TE is not less than half of the first thickness TB. The second thickness TE is not greater than the cushioning thickness TB. Each of the plurality of the elastic members 30 has a circular circumferential shape, but not limiting. The plurality of elastic members 30 and the cushion layer 24 are connected together by an integral forming method, but not limiting

Furthermore, the substrate 23 has an original thickness in the thickness direction of the strap body 20 defining a third thickness TF. The first thickness TB is between 0.8 and 1.2 times of the third thickness TF. The first thickness TB equals to the third thickness TF.

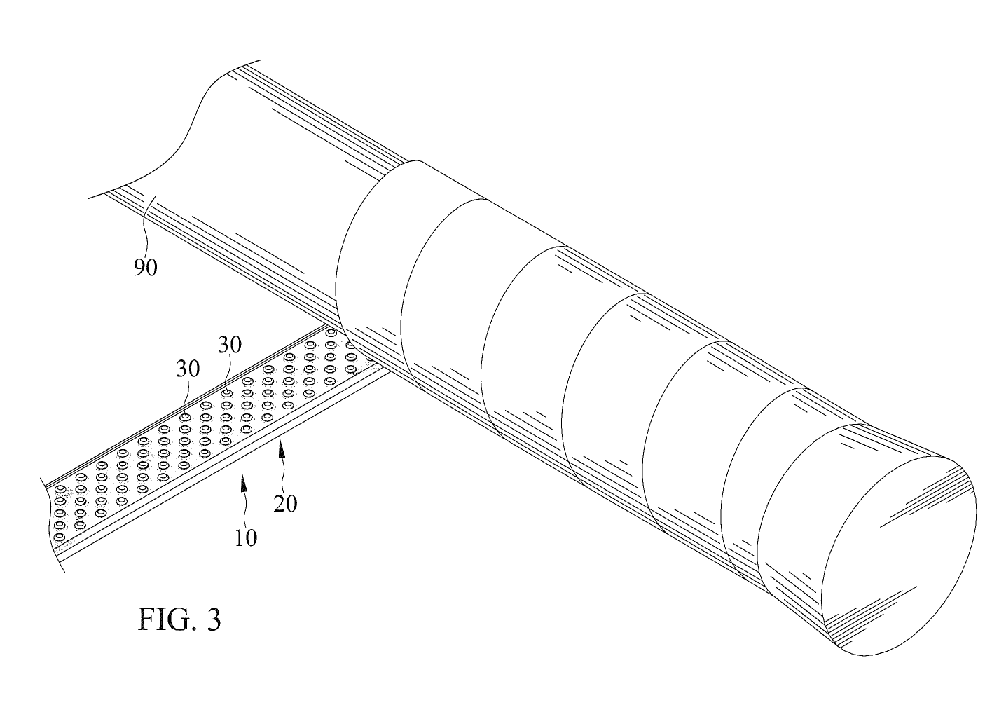

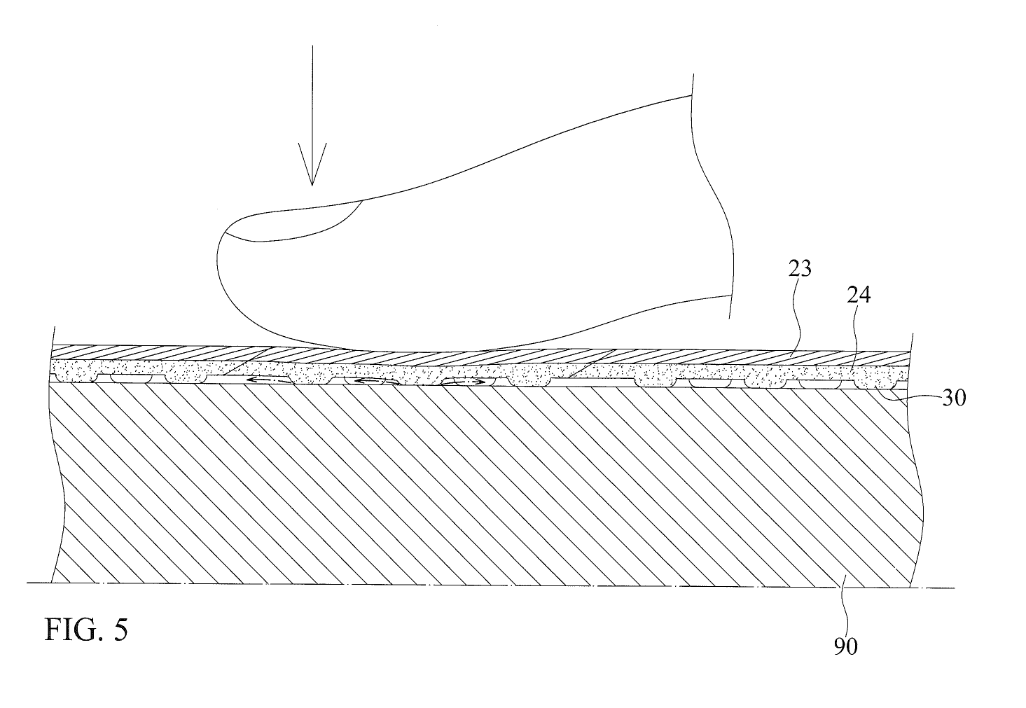

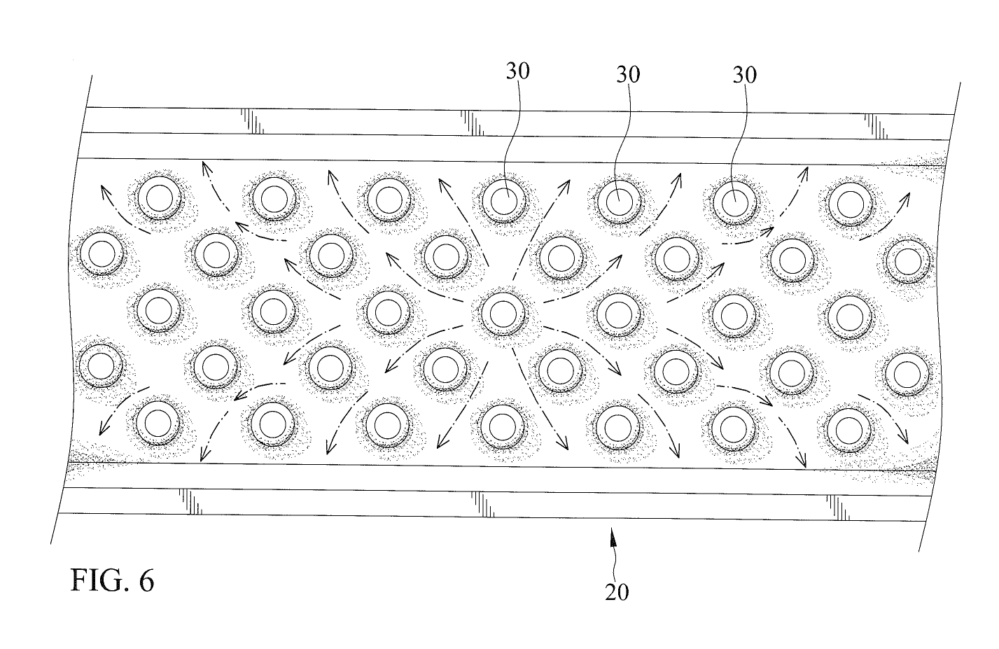

As shown in FIG. 3, the grip strap 10 is wrapped spirally around the handle 90 with the plurality of elastic members 30 facing and abutting against the handle 90 and the front side 21 of the strap body 20 enclosing the plurality of the elastic members 30. Therefore, each of the plurality of elastic members 30 has the top edge in frictional contact with the outer periphery of the handle 90 and will prevent the grip strap 10 slip relative to the handle 90 inadvertently, and a user will grip on the front side 21 of the strap body 20 when gripping the grip strap 10 and the handle 90. Also, since the front side 21 of the strap body 20 is smooth and flat, the user can comfortably grip on the front side 21 of the strap body 20 when gripping the grip strap 10 and the handle 90. Additionally, as shown in FIGS. 5 and 6, a plurality of air channels are created between the back side 22 of the strap body 20 and the outer periphery of the handle 90. Therefore, the user is able to experience a ventilation effect when gripping the handle 90 wrapped by the grip strap 10. Additionally, the plurality of air channels let the user experience an extra anti shock effect.

In view of the forgoing, the cushion layer 24 and the elastic members 30 can absorb impact energy and let a user experience an anti shock effect. The plurality of air channels can let the user experience extra anti shock and ventilation effects when gripping the handle 90 wrapped by the grip strap 10.

The foregoing is merely illustrative of the principles of this invention and various modifications can be made by those skilled in the art without departing from the scope and spirit of the invention.

What is claimed is:

1. A grip strap with anti-shock and ventilation effects comprising:
a strap body including a front side and a back side opposite the front side; and
a plurality of elastic members disposed on the back side of the strap body and arranged separately from one another and including each protruding from the back side of the strap body in a direction away from the front side of the strap body.

2. The grip strap as claimed in claim 1, wherein the strap body includes a substrate and a cushion layer overlapping the substrate, with the substrate and the cushion layer arranged in a thickness direction of the strap body, and wherein the substrate is adjacent to the front side of the strap body and the cushion layer is adjacent to the back side of the strap body, respectively.

3. The grip strap as claimed in claim 2, wherein the cushion layer has an original thickness in the thickness direction of the strap body defining a first thickness, wherein each of the plurality of elastic member has an original thickness in the thickness direction of the strap body defining a second thickness, and wherein the second thickness is not less than half of the first thickness.

4. The grip strap as claimed in claim 3, wherein the second thickness is not greater than the cushioning thickness.

5. The grip strap as claimed in claim 3, wherein the substrate has an original thickness in the thickness direction of the strap body defining a third thickness, and wherein the first thickness is between 0.8 and 1.2 times of the third thickness.

6. The grip strap as claimed in claim 5, wherein the first thickness equals to the third thickness.

7. The grip strap as claimed in claim 2, wherein the cushion layer is made of an elastomer material.

8. The grip strap as claimed in claim 7, wherein the cushion layer is made of Ethylene Vinyl Acetate.

9. The grip strap as claimed in claim 7, wherein the cushion layer is made of Thermoplastic Polyurethane.

10. The grip strap as claimed in claim 1, wherein the plurality of elastic members and the cushion layer are connected together by an integral forming method.

11. The grip strap as claimed in claim 1, wherein each of the plurality of elastic members has a bottom edge in contact with the back side of the strap body and a top edge opposite to the bottom edge, and wherein the top edges of the plurality of elastic members are at the same height.

12. The grip strap as claimed in claim 1, wherein the plurality of elastic members is disposed along the longitudinal length direction of strap body.

13. The grip strap as claimed in claim 1, wherein the front side of the strap body is a flat smooth edge without any cavities.

14. The grip strap as claimed in claim 1 further comprising a combination with a handle, wherein the plurality of elastic members faces and abuts against the handle and the front side of the strap body encloses the plurality of the elastic members, and wherein the back side of the strap body and an outer periphery of the handle delimit a plurality of air channels therebetween.
